(19) United States
(12) Patent Application Publication
(10) Pub. No.: US 2026/0366364 A1
(43) Pub. Date: Nov. 19, 2026

(54) RETRACTABLE GATE BARRIER

(71) Applicant: GUANGZHOU TUSUNNY HOME PRODUCTS CO., LTD, Guangzhou (CN)

(72) Inventor: Hongjuan WANG, Guangzhou (CN)

(73) Assignee: GUANGZHOU TUSUNNY HOME PRODUCTS CO., LTD, Guangzhou (CN)

(21) Appl. No.: 19/238,707

(22) Filed: Jun. 16, 2025

(30) Foreign Application Priority Data
May 19, 2025 (CN) 202510645335.7

(51) Int. Cl. E06B 9/06; E06B 9/60; E06B 9/80; E06B 9/78

(52) U.S. Cl. CPC E06B 9/0692; E06B 9/60; E06B 9/80; E06B 9/78; E06B 2009/801

(57) ABSTRACT

The present disclosure discloses a telescopic gate barrier. The telescopic gate barrier comprises: a first fixed seat and a second fixed seat, spaced apart from each other; a rotating drum, rotatably connected at both ends to the first fixed seat and the second fixed seat; a partition cloth, fixed at one end to the rotating drum and wound around the rotating drum; a torsion spring, arranged in the rotating drum and extending through the rotating drum, fixed at one end to the rotating drum and connected at another end to the first fixed seat; a torsion member, connected to an end of the torsion spring close to the first fixed seat, extending out of the first fixed seat, and configured to twist the torsion spring; and a locking assembly, connected to the first fixed seat, configured to lock a twisted position of the torsion member.

### CROSS-REFERENCE TO RELATED APPLICATIONS

This application claims priority to Chinese Patent Application No. 202510645335.7, filed on May 19, 2025, which is incorporated herein by reference in its entirety.

### TECHNICAL FIELD

The present disclosure relates to the technical field of gate barriers, particularly to a retractable gate barrier.

### BACKGROUND

As a common spatial partitioning device, retractable gate barriers are primarily used in residential interiors or garden landscapes. The device realizes physical partitioning through a retractable structure, enabling quick division of temporary activity areas according to usage requirements. In indoor scenarios, the flexible characteristics of the retractable gate barrier support dynamic partitioning of spaces such as living rooms and corridors; in outdoor garden environments, the retractable gate barrier effectively delineates functional garden zones.

In related art, a retractable gate barrier includes fixed seats, a rotating drum, and a partition cloth. Two fixed seats are provided, and are positioned at both ends of the rotating drum, and the rotating drum is rotationally connected to the fixed seats. One end of the partition cloth is fixed to the rotating drum, and the partition cloth is wound around the rotating drum. A torsion spring is arranged in the rotating drum. When a user pulls the free end of the partition cloth, the rotating drum rotates, driving the torsion spring to rotate and generate a return torque. After the free end of the partition cloth is pulled a certain distance and fixed, the partition cloth becomes taut under the return torque of the torsion spring. When the free end of the partition cloth is released, the rotating drum rotates in the opposite direction under the return torque of the torsion spring, enabling automatic retraction of the partition cloth.

However, since the taut state of the partition cloth relies on the return torque of the torsion spring, the partition cloth must be pulled a certain length before achieving tautness. In scenarios requiring small partitioning distances, the pulled distance of the partition cloth is limited, resulting in insufficient return torque from the torsion spring. Consequently, the partition cloth struggles to remain taut, adversely affecting user experience.

To enable the partition cloth to remain taut even when pulled over a small distance, the present disclosure provides a retractable gate barrier.

The retractable gate barrier provided in the present disclosure adopts the following technical solutions:

A retractable gate barrier, comprising: a first fixed seat and a second fixed seat, spaced apart from each other; a rotating drum, rotatably connected at both ends to the first fixed seat and the second fixed seat; a partition cloth, fixed at one end to the rotating drum and wound around the rotating drum; a torsion spring, arranged in the rotating drum and extending through the rotating drum, fixed at one end to the rotating drum and connected at another end to the first fixed seat; a torsion member, connected to an end of the torsion spring close to the first fixed seat, extending out of the first fixed seat, and configured to twist the torsion spring; and a locking assembly, connected to the first fixed seat, configured to lock a twisted position of the torsion member.

By employing the above technical solution, when a user needs to use the retractable gate barrier, the first fixed seat and the second fixed seat are fixed to desired positions. The free end of the partition cloth is then pulled to the required position and fixed, completing the partitioning. At this point, the user checks whether the partition cloth has reached a taut state. If not, the user first releases the locking assembly to allow the torsion member to twist the torsion spring. The torsion spring is then twisted in the direction of tightening, i.e., increasing the return torque of the torsion spring, thereby enhancing the return torque and tautening the partition cloth. This enables the partition cloth to remain taut even when pulled over a small distance.

Additionally, when the user pulls the partition cloth over a longer distance, the return torque of the torsion spring increases, making operation more laborious for certain users, such as children and the elderly. For such cases, the user may first release the locking assembly to allow the torsion member to twist the torsion spring. The torsion spring is then twisted in the loosening direction to reduce the initial torque of the torsion spring, thereby decreasing the effort required for subsequent pulling of the partition cloth.

In some embodiments, the locking assembly comprises: a locking plate, fixed to the first fixed seat, wherein one end of the torsion member extends through the locking plate; a tensioning member, connected to an extended end of the torsion member, configured to pull the torsion member such that another end of the torsion member is pressed against the locking plate; and wherein the torsion member is slidably connected to the torsion spring and configured to slide along an axial direction of the torsion spring.

By employing the above technical solution, when the user locks the torsion member using the locking assembly, the tensioning member pulls the torsion member tightly against the locking plate. Significant friction is generated between the torsion member and the locking plate, preventing relative rotation between the torsion member and the locking plate. The position of the torsion member is thus locked, and the rotational position of the torsion spring is fixed. Since the tensioning member applies a pulling force to the torsion member, the sliding connection between the torsion member and the torsion spring prevents simultaneous pulling of the torsion spring, ensuring unimpeded functionality of the torsion spring.

In some embodiments, a locking hole is formed at a position on the locking plate that opposes the torsion member, the locking hole is conically configured, and a diameter of the locking hole gradually increases from the extended end of the torsion member toward an opposite end of the torsion member; and a sidewall of the torsion member that opposes the locking hole is conically configured and matches the sidewall of the locking hole.

By employing the above technical solution, when the user locks the torsion member, the tensioning member pulls the torsion member, causing the conical sidewalls of the torsion member to conform to the conical sidewalls of the locking hole. As the tensioning member gradually pulls the torsion member, the sidewalls of the torsion member increasingly press against the sidewalls of the locking hole. Friction between the torsion member and the locking plate progressively increases, hindering rotation of the torsion member. The conical interface between the locking hole and the torsion member provides a large friction surface, ensuring secure locking of the torsion member. Furthermore, since the locking hole and the torsion member are fitted together via a conical interface, and the conical interface is a rotational symmetric surface, the torsion member can be locked at any rotational position, enabling stepless adjustment of the torsion spring's return torque.

In some embodiments, the torsion member is provided with a rotation-blocking hole, an end of the torsion spring extends into the rotation-blocking hole, the torsion member is slidably sleeved over the end of the torsion spring via the rotation-blocking hole, and the rotation-blocking hole blocks relative rotation between the torsion member and the torsion spring.

By employing the above technical solution, when the torsion member and the torsion spring are assembled, the end of the torsion spring is simply inserted into the rotation-blocking hole. This achieves both a sliding connection between the torsion member and the torsion spring and prevents relative rotation between the torsion member and the torsion spring, facilitating quick and convenient assembly between the torsion member and the torsion spring.

In some embodiments, the tensioning member comprises a rotating ring, the rotating ring is threadedly connected to the extended end of the torsion member, and the rotating ring is detachably abutted against the locking plate.

By employing the above technical solution, when the user pulls the torsion member using the tensioning member, the rotating ring is turned. The rotating ring initially abuts against the locking plate, and as rotation of the rotating ring continues, due to the threaded connection, the extended end of the torsion member continues to extend out of the rotating ring. The pressing force between the torsion member and the locking plate gradually intensifies until the rotating ring can no longer turn, locking the torsion member. Due to the self-locking property of the threads, relative rotation between the rotating ring and the torsion member is stably prevented, ensuring secure locking of the torsion member.

In some embodiments, a torsion handle is fixed to the extended end of the torsion member, and the torsion handle is configured to twist the torsion member; and a toggle handle is fixed to the rotating ring, and the toggle handle is configured to rotate the rotating ring.

By employing the above technical solution, when the user needs to twist the torsion member to adjust the torsion spring's torque, the user first loosens the rotating ring via the toggle handle. Then, the user uses the handle to turn the torsion member, thereby adjusting the spring torque. After adjustment, the user toggles the rotating ring in the opposite direction via the toggle handle to lock the torsion member. The coordination between the toggle handle and the handle simplifies the user's adjustment process for the torsion spring's torque.

In some embodiments, the first fixed seat is hollow, and the locking plate is fixed to an open end of the first fixed seat.

By employing the above technical solution, the portion of the torsion member cooperating with the torsion spring can be concealed within the first fixed seat, enhancing aesthetic uniformity. Additionally, the entire circumference of the locking plate is supported by the first fixed seat, ensuring stable connection between the locking plate and the first fixed seat. The ends of the torsion spring are connected in a stable manner, enabling stable extension and retraction of the partition cloth.

In some embodiments, a mounting plate is arranged at an end of the first fixed seat away from the torsion member; an end mounting member is fixed to an end of the rotating drum, the end mounting member is embedded in and is rotatably connected to the mounting plate; and a rotation locking member is connected to the mounting plate, and the rotation locking member is configured to lock rotation of the end mounting member.

By employing the above technical solution, when the partition cloth is extended to partition a space, the locking member locks the rotating drum to prevent further pulling of the partition cloth, ensuring effective spatial partitioning of the partition cloth. Moreover, the torsion member and the locking member are positioned at opposite ends of the first fixed seat. The operational areas for the torsion member and the locking member are proximate yet non-interfering, facilitating user adjustment of the torsion spring's torque and locking of the rotating drum.

In some embodiments, the mounting plate is provided with an axial hole and an accommodation hole that are interconnected, and the axial hole and the accommodation hole are along the axial direction of the torsion spring; and the end mounting member comprises a sleeve and an end plate that are fixed to each other, a diameter of the end plate is larger than a diameter of the sleeve, the sleeve is sleeved over the rotating drum, the end plate is located in the accommodation hole, and the rotation locking member is configured to lock rotation of the end plate.

By employing the above technical solution, the cooperation between the axial hole and the sleeve enables rotational engagement between the rotating drum and the first fixed seat. Locking the end plate via the locking member locks the rotation of the sleeve, thereby locking the rotating drum and achieving bidirectional locking of the rotating drum.

In some embodiments, the rotation locking member comprises a compression ring, and the compression ring extends into the accommodation hole and is threadedly connected to the mounting plate to compress the end plate.

By employing the above technical solution, rotating the compression ring gradually presses the end plate. Once the end plate is compressed, the end plate is locked, securing the rotating drum. The self-locking property of the threads ensures reliable locking of the rotating drum.

In summary, the present disclosure includes at least one of the following beneficial technical effects:
1. When a user needs to use the retractable gate barrier, the first fixed seat and the second fixed seat are fixed to desired positions. The free end of the partition cloth is then pulled to the required position and fixed, completing the partitioning. At this point, the user checks whether the partition cloth has reached a taut state. If not, the user first releases the locking assembly to allow the torsion member to twist the torsion spring. The torsion spring is then twisted in the direction of tightening, i.e., increasing the return torque of the torsion spring, thereby enhancing the return torque and tautening the partition cloth. This enables the partition cloth to remain taut even when pulled over a small distance.
2. When the user locks the torsion member, the tensioning member pulls the torsion member, causing the conical sidewalls of the torsion member to conform to the conical sidewalls of the locking hole. As the tensioning member gradually pulls the torsion member, the sidewalls of the torsion member increasingly press against the sidewalls of the locking hole. Friction between the torsion member and the locking plate progressively increases, hindering rotation of the torsion member. The conical interface between the locking hole and the torsion member provides a large friction surface, ensuring secure locking of the torsion member. Furthermore, since the locking hole and the torsion member are fitted together via a conical interface, and the conical interface is a rotational symmetric surface, the torsion member can be locked at any rotational position, enabling stepless adjustment of the torsion spring's return torque.
3. When the partition cloth is extended to partition a space, the locking member locks the rotating drum to prevent further pulling of the partition cloth, ensuring effective spatial partitioning of the partition cloth. Moreover, the torsion member and the locking member are positioned at opposite ends of the first fixed seat. The operational areas for the torsion member and the locking member are proximate yet non-interfering, facilitating user adjustment of the torsion spring's torque and locking of the rotating drum.

### BRIEF DESCRIPTION OF THE DRAWINGS

In order to more clearly illustrate the technical solutions in the embodiments of the present disclosure, the drawings needed to be used in the description of the embodiments will be briefly introduced below. Obviously, the drawings in the following description are some embodiments of the present disclosure, and for a person of ordinary skill in the art, other drawings can also be obtained based on these drawings without exerting creative efforts.

FIG. 1 is a schematic diagram of the overall structure of the retractable gate barrier in the embodiments of the present disclosure;

FIG. 2 is a schematic diagram of the internal structure of the retractable gate barrier in the embodiments of the present disclosure;

FIG. 3 is an enlarged view of section A in FIG. 2;

FIG. 4 is a schematic diagram of the internal structure of the first fixed seat in the embodiments of the present disclosure;

FIG. 5 is an exploded view showing the cooperation among the torsion member, the torsion spring, and the rotating drum;

FIG. 6 is a schematic structural diagram of the locking member in the embodiments of the present disclosure.

The reference numerals are as follows:
1, first fixed seat;
11, mounting plate;
111, axial hole;
12, accommodation hole;
2, second fixed seat;
3, rotating drum;
31, connecting plate;
311, connecting hole;
32, end mounting member;
321, sleeve;
322, end plate;
4, partition cloth;
5, torsion spring;
51, nut;
6, torsion member;
61, rotation-blocking hole;
62, torsion handle;
7, locking assembly;
71, locking plate;
711, locking hole;
72, tensioning member;
21, rotating ring;
722, toggle handle;
8, rotation locking member;
81, compression ring;
811, toggle plate;
812, toggle bar.

### DETAILED DESCRIPTION OF THE EMBODIMENTS

The technical solutions of the present disclosure will be clearly and completely described below with reference to the accompanying drawings. Obviously, the described embodiments are a part of the embodiments of the present disclosure, rather than all of the embodiments. Based on the embodiments of the present disclosure, all other embodiments obtained by those of ordinary skill in the art without creative efforts fall within the scope of protection of the present disclosure.

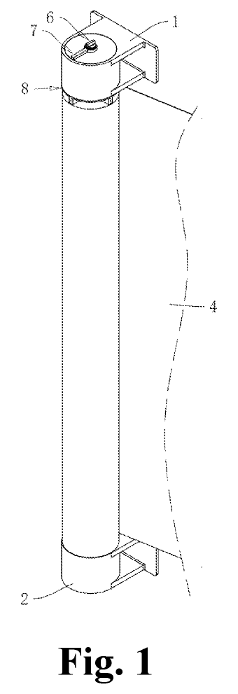

The following provides a detailed explanation of the present disclosure with reference to FIGS. 1-6.

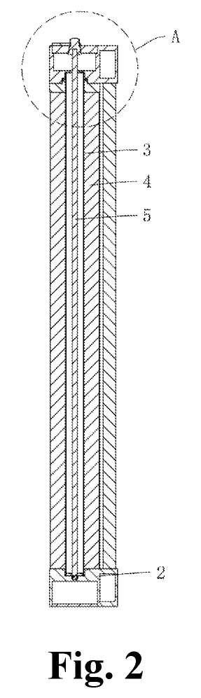

Referring to FIGS. 1-2, the present disclosure discloses an embodiment of a retractable gate barrier. The retractable gate barrier comprises a first fixed seat 1, a second fixed seat 2, a rotating drum 3, a partition cloth 4, a torsion spring 5, a torsion member 6, and a locking assembly 7. The first fixed seat 1 and the second fixed seat 2 are spaced apart from each other. The rotating drum 3 is rotatably connected at both ends to the first fixed seat 1 and the second fixed seat 2. The partition cloth 4 is fixed at one end to the rotating drum 3, and the partition cloth 4 is wound around the rotating drum 3. The other end of the partition cloth 4 is a free end for pulling. The torsion spring 5 is arranged in the rotating drum 3 and extending through the rotating drum 3, fixed at one end to the rotating drum 3 and connected at another end to the first fixed seat 1. The torsion member 6 is connected to an end of the torsion spring 5 close to the first fixed seat 1, extending out of the first fixed seat 1, and configured to twist the torsion spring 5. A locking assembly 7 is connected to the first fixed seat 1, configured to lock a twisted position of the torsion member 6.

When a user needs to use the retractable gate barrier, the first fixed seat 1 and the second fixed seat 2 are fixed to desired positions. The free end of the partition cloth 4 is then pulled to the required position and fixed, completing the partitioning. At this point, the user checks whether the partition cloth 4 has reached a taut state. If not, the user first releases the locking assembly 7 to allow the torsion member 6 to twist the torsion spring 5. The torsion spring 5 is then twisted in the direction of tightening, i.e., increasing the return torque of the torsion spring 5, thereby enhancing the return torque and tautening the partition cloth 4. This enables the partition cloth 4 to remain taut even when pulled over a small distance.

In addition to the above operation, the user may first twist the torsion spring 5 via the torsion member 6 before pulling the partition cloth 4, increasing the torque of the torsion spring 5 to enhance the tautening effect of the partition cloth 4.

Additionally, when the user pulls the partition cloth 4 over a longer distance, the return torque of the torsion spring 5 increases, making operation more laborious for certain users, such as children and the elderly. For such cases, the user may first release the locking assembly 7 to allow the torsion member 6 to twist the torsion spring 5. The torsion spring 5 is then twisted in the loosening direction to reduce the initial torque of the torsion spring 5, thereby decreasing the effort required for subsequent pulling of the partition cloth 4.

In this embodiment of the present disclosure, the first fixed seat 1 and the second fixed seat 2 are equivalent. The torsion member 6 and the locking assembly 7 may also be arranged on the second fixed seat 2. Typically, the first fixed seat 1 and the second fixed seat 2 are spaced vertically. As shown in FIG. 1, the first fixed seat 1 is the upper fixed seat, and the second fixed seat 2 is the lower fixed seat. In other embodiments, the first fixed seat 1 may serve as the lower fixed seat, and the second fixed seat 2 as the upper fixed seat. For ease of operation, the torsion member 6 and the locking assembly 7 are typically arranged on the upper fixed seat. However, in scenarios where the first fixed seat 1 and the second fixed seat 2 are suspended at a height, the first fixed seat 1 may refer to the lower fixed seat to facilitate user operation for the retractable gate barrier.

Referring to FIGS. 1-3, the locking assembly 7 comprises a locking plate 71 and a tensioning member 72. The locking plate 71 is fixed to the first fixed seat 1, wherein one end of the torsion member 6 extends through the locking plate 71. The tensioning member 72 is connected to an extended end of the torsion member 6, configured to pull the torsion member 6 such that another end of the torsion member 6 is pressed against the locking plate 71. The torsion member 6 is slidably connected to the torsion spring 5 and configured to slide along an axial direction of the torsion spring 5.

When the user locks the torsion member 6 using the locking assembly 7, the tensioning member 72 pulls the torsion member 6 tightly against the locking plate 71. Significant friction is generated between the torsion member 6 and the locking plate 71, preventing relative rotation between the torsion member 6 and the locking plate 71. The position of the torsion member 6 is thus locked, and the rotational position of the torsion spring 5 is fixed. Since the tensioning member 72 applies a pulling force to the torsion member 6, the sliding connection between the torsion member 6 and the torsion spring 5 prevents simultaneous pulling of the torsion spring 5, ensuring unimpeded functionality of the torsion spring 5.

Referring to FIGS. 1-3, a locking hole 711 is formed at a position on the locking plate 71 that opposes the torsion member 6, the locking hole 711 is conically configured, and a diameter of the locking hole 711 gradually increases from the extended end of the torsion member 6 toward an opposite end of the torsion member 6; and a sidewall of the torsion member 6 that opposes the locking hole 711 is conically configured and matches the sidewall of the locking hole 711.

When the user locks the torsion member 6, the tensioning member 72 pulls the torsion member 6, causing the conical sidewalls of the torsion member 6 to conform to the conical sidewalls of the locking hole 711. As the tensioning member 72 gradually pulls the torsion member 6, the sidewalls of the torsion member 6 increasingly press against the sidewalls of the locking hole 711. Friction between the torsion member 6 and the locking plate 71 progressively increases, hindering rotation of the torsion member 6. The conical interface between the locking hole 711 and the torsion member 6 provides a large friction surface, ensuring secure locking of the torsion member 6. Furthermore, since the locking hole 711 and the torsion member 6 are fitted together via a conical interface, and the conical interface is a rotational symmetric surface, the torsion member 6 can be locked at any rotational position, enabling stepless adjustment of the torsion spring 5's return torque. Compared to traditional ratchet mechanisms for rotational position locking, this friction-based solution not only ensures stable locking but also simplifies the ratchet structure, improves reliability, and reduces costs.

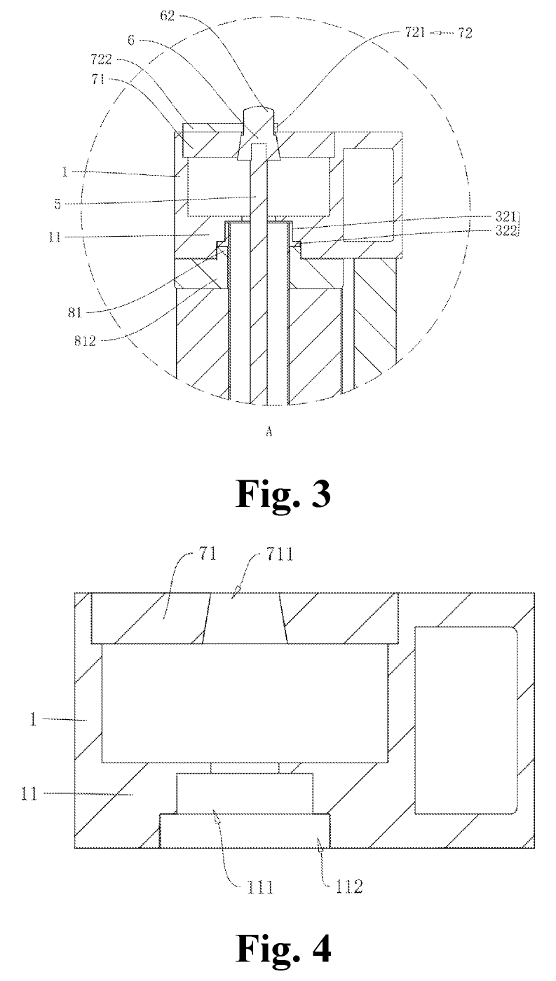

Referring to FIG. 3, the tensioning member 72 comprises a rotating ring 721, the rotating ring 721 is threadedly connected to the extended end of the torsion member 6, and the rotating ring 721 is detachably abutted against the locking plate 71. When the user pulls the torsion member 6 using the tensioning member 72, the rotating ring 721 is turned. The rotating ring 721 initially abuts against the locking plate 71, and as rotation of the rotating ring 721 continues, due to the threaded connection, the extended end of the torsion member 6 continues to extend out of the rotating ring 721. The pressing force between the torsion member 6 and the locking plate 71 gradually intensifies until the rotating ring 721 can no longer turn, locking the torsion member 6. Due to the self-locking property of the threads, relative rotation between the rotating ring 721 and the torsion member 6 is stably prevented, ensuring secure locking of the torsion member 6.

For the locking assembly 7, in addition to the above embodiments, in other embodiments, the locking assembly 7 may also comprise a locking plate 71 and a rotating ring 721. The locking plate 71 is fixed to the first fixed seat 1, and a through-hole is formed at the position corresponding to the tensioning member 72. One end of the torsion member 6 extends through the through-hole in the locking plate 71, and the rotating ring 721 is threadedly connected to the extended end of the torsion member 6. A stopper plate is fixed to the opposite end of the torsion member 6, and a diameter of the stopper plate is larger than a diameter of the through-hole. When the user tightens the rotating ring 721 to pull the torsion member 6, the stopper plate presses against the locking plate 71. As the rotating ring 721 is further tightened, friction between the stopper plate and the locking plate 71 increases, ultimately preventing relative rotation between the torsion member 6 and the locking plate 71, thereby achieving locking of the torsion member 6.

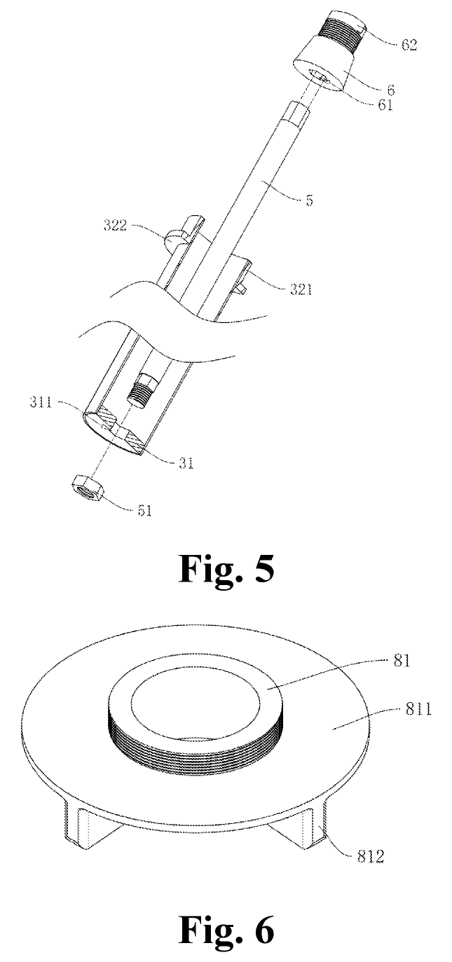

Referring to FIG. 5, the torsion member 6 is provided with a rotation-blocking hole 61. The end of the torsion spring 5 extends into the rotation-blocking hole 61, connecting the end of the torsion spring 5 to the torsion member 6. Specifically, the rotation-blocking hole 61 may be a polygonal hole, an elliptical hole, or other irregularly shaped holes. For example, the shape of the rotation-blocking hole 61 may be triangular, quadrilateral, pentagonal, hexagonal, elliptical, or other shapes. As shown in FIG. 5, in this embodiment of the present disclosure, the rotation-blocking hole 61 is preferably hexagonal. The end of the torsion spring 5 close to the torsion member 6 is hexagonal, and the torsion member 6 is slidably sleeved over the end of the torsion spring 5 via the rotation-blocking hole 61, allowing the torsion member 6 to slide along the axial direction of the torsion spring 5 while preventing relative rotation.

When the torsion member 6 and the torsion spring 5 are assembled, the end of the torsion spring 5 is simply inserted into the rotation-blocking hole 61. This achieves both a sliding connection between the torsion member 6 and the torsion spring 5 and prevents relative rotation between the torsion member 6 and the torsion spring 5, facilitating quick and convenient assembly between the torsion member 6 and the torsion spring 5.

Continuing with FIG. 5, one end of the torsion spring 5 away from the torsion member 6 is connected to the rotating drum 3. A connecting plate 31 is fixed to the rotating drum 3. A connecting hole 311 is provided at a position of the connecting plate 31 opposite to the torsion spring 5. The connecting hole 311 is hexagonal. The end of the torsion spring 5 is also hexagonal at the position where it mates with the connecting hole 311. When the torsion spring 5 is inserted into the connecting plate 31 through the connecting hole 311, the rotating drum 3 and the torsion spring 5 cannot rotate relatively. To prevent axial displacement between the rotating drum 3 and the torsion spring 5, a nut 51 is threadedly connected to the end of the torsion spring 5 after the torsion spring 5 extends through the connecting plate 31 through the connecting hole 311.

Referring to FIG. 1, a torsion handle 62 is fixed to the extended end of the torsion member 6, and the torsion handle 62 is configured to twist the torsion member 6. A toggle handle 722 is fixed to the rotating ring 721, and the toggle handle 722 is configured to rotate the rotating ring 721. When the user needs to twist the torsion member 6 to adjust the torsion spring 5's torque, the user first loosens the rotating ring 721 via the toggle handle 722. Then, the user uses the handle to turn the torsion member 6, thereby adjusting the spring torque. After adjustment, the user toggles the rotating ring 721 in the opposite direction via the toggle handle 722 to lock the torsion member 6. The coordination between the toggle handle 722 and the handle simplifies the user's adjustment process for the torsion spring 5's torque.

Referring to FIG. 2, the first fixed seat 1 is hollow, and the locking plate 71 is fixed to the open end of the first fixed seat 1. The portion of the torsion member 6 cooperating with the torsion spring 5 is concealed within the first fixed seat 1, enhancing aesthetic uniformity. The entire circumference of the locking plate 71 is supported by the first fixed seat 1, ensuring stable connection between the locking plate 71 and the first fixed seat 1. The ends of the torsion spring 5 are connected in a stable manner, enabling stable extension and retraction of the partition cloth 4.

Referring to FIGS. 1, 2, and 5, a mounting plate 11 is arranged at an end of the first fixed seat 1 away from the torsion member 6. An end mounting member 32 is fixed to an end of the rotating drum 3, and the end mounting member 32 is embedded in and is rotatably connected to the mounting plate 11. A rotation locking member 8 is connected to the mounting plate 11, and the rotation locking member 8 is configured to lock rotation of the end mounting member 32.

When the partition cloth 4 is extended to partition a space, the locking member locks the rotating drum 3 to prevent further pulling of the partition cloth 4, ensuring effective spatial partitioning of the partition cloth 4. Moreover, the torsion member 6 and the locking member are positioned at opposite ends of the first fixed seat 1. The operational areas for the torsion member 6 and the locking member are proximate yet non-interfering, facilitating user adjustment of the torsion spring 5's torque and locking of the rotating drum 3.

Referring to FIGS. 1-4, the mounting plate 11 is provided with an axial hole 111 and an accommodation hole 112 that are interconnected, and the axial hole 111 and the accommodation hole 112 are along the axial direction of the torsion spring 5. The end mounting member 32 comprises a sleeve 321 and an end plate 322 that are fixed to each other, a diameter of the end plate 322 is larger than a diameter of the sleeve 321, the sleeve 321 is sleeved over the rotating drum 3, the sleeve 321 is located in the axial hole 111, the end plate 322 is located in the accommodation hole 112, and the locking member is configured to lock rotation of the end plate 322. The sleeve 321 and the axial hole 111 have a small clearance fit to ensure rotational stability between the sleeve 321 and the first fixed seat 1.

The cooperation between the axial hole 111 and the sleeve 321 enables rotational engagement between the rotating drum 3 and the first fixed seat 1. Locking the end plate 322 via the locking member locks the rotation of the sleeve 321, thereby locking the rotating drum 3 and achieving bidirectional locking of the rotating drum 3.

Referring to FIGS. 3-6, the rotation locking member 8 comprises a compression ring 81, and the compression ring 81 extends into the accommodation hole 112 and is threadedly connected to the mounting plate 11 to compress the end plate 322. By rotating the compression ring 81, the compression ring 81 gradually presses the end plate 322. Once the end plate 322 is compressed, the end plate 322 is locked, securing the rotating drum 3. The self-locking property of the threads ensures reliable locking of the rotating drum 3.

To facilitate rotation of the compression ring 81, referring to FIGS. 3-6, a toggle plate 811 is fixedly connected to one side of the compression ring 81 away from the end plate 322, and a plurality of toggle bars 812 are integrally formed on the toggle plate 811. When the user needs to lock the rotation of the rotating drum 3, the compression ring 81 is rotated by the toggle bars 812, thereby facilitating the user locking the rotating drum 3.

An implementation principle of the retractable gate barrier in this embodiment of the present disclosure is that when a user needs to use the retractable gate barrier, the first fixed seat 1 and the second fixed seat 2 are fixed to desired positions. The free end of the partition cloth 4 is then pulled to the required position and fixed, completing the partitioning. At this point, the user checks whether the partition cloth 4 has reached a taut state. If not, the user first releases the locking assembly 7 to allow the torsion member 6 to twist the torsion spring 5. The torsion spring 5 is then twisted in the direction of tightening, i.e., increasing the return torque of the torsion spring 5, thereby enhancing the return torque and tautening the partition cloth 4. This enables the partition cloth 4 to remain taut even when pulled over a small distance.

Finally, it should be noted that the above embodiments are provided to illustrate the technical solutions of the present disclosure and are not intended to limit them; although the present disclosure has been described in detail with reference to the above embodiments, those skilled in the art should understand that the technical solutions recorded in the above embodiments may still be modified, or some or all of the technical features may be equivalently substituted; and such modifications or substitutions do not cause the essence of the corresponding technical solutions to depart from the scope of the technical solutions of the embodiments of the present disclosure.

What is claimed is:

1. A telescopic gate barrier, comprising:
a first fixed seat (1) and a second fixed seat (2), spaced apart from each other;
a rotating drum (3), rotatably connected at both ends to the first fixed seat (1) and the second fixed seat (2);
a partition cloth (4), fixed at one end to the rotating drum (3) and wound around the rotating drum (3);
a torsion spring (5), arranged in the rotating drum (3) and extending through the rotating drum (3), fixed at one end to the rotating drum (3) and connected at another end to the first fixed seat (1);
a torsion member (6), connected to an end of the torsion spring (5) close to the first fixed seat (1), extending out of the first fixed seat (1), and configured to twist the torsion spring (5); and
a locking assembly (7), connected to the first fixed seat (1), configured to lock a twisted position of the torsion member (6).

2. The telescopic gate barrier according to claim 1, wherein the locking assembly (7) comprises:
a locking plate (71), fixed to the first fixed seat (1), wherein one end of the torsion member (6) extends through the locking plate (71);
a tensioning member (72), connected to an extended end of the torsion member (6), configured to pull the torsion member (6) such that another end of the torsion member (6) is pressed against the locking plate (71); and
wherein the torsion member (6) is slidably connected to the torsion spring (5) and configured to slide along an axial direction of the torsion spring (5).

3. The telescopic gate barrier according to claim 2, wherein a locking hole (711) is formed at a position on the locking plate (71) that opposes the torsion member (6), the locking hole (711) is conically configured, and a diameter of the locking hole (711) gradually increases from the extended end of the torsion member (6) toward an opposite end of the torsion member (6); and a sidewall of the torsion member (6) that opposes the locking hole (711) is conically configured and matches the sidewall of the locking hole (711).

4. The telescopic gate barrier according to claim 2, wherein the torsion member (6) is provided with a rotation-blocking hole (61), an end of the torsion spring (5) extends into the rotation-blocking hole (61), the torsion member (6) is slidably sleeved over the end of the torsion spring (5) via the rotation-blocking hole (61), and the rotation-blocking hole (61) blocks relative rotation between the torsion member (6) and the torsion spring (5).

5. The telescopic gate barrier according to claim 2, wherein the tensioning member (72) comprises a rotating ring (721), the rotating ring (721) is threadedly connected to the extended end of the torsion member (6), and the rotating ring (721) is detachably abutted against the locking plate (71).

6. The telescopic gate barrier according to claim 5, wherein a torsion handle (62) is fixed to the extended end of the torsion member (6), and the torsion handle (62) is configured to twist the torsion member (6); and
a toggle handle (722) is fixed to the rotating ring (721), and the toggle handle (722) is configured to rotate the rotating ring (721).

7. The telescopic gate barrier according to claim 2, wherein the first fixed seat (1) is hollow, and the locking plate (71) is fixed to an open end of the first fixed seat (1).

8. The telescopic gate barrier according to claim 1, wherein a mounting plate (11) is arranged at an end of the first fixed seat (1) away from the torsion member (6); an end mounting member (32) is fixed to an end of the rotating drum (3), the end mounting member (32) is embedded in and is rotatably connected to the mounting plate (11); and
a rotation locking member (8) is connected to the mounting plate (11), and the rotation locking member (8) is configured to lock rotation of the end mounting member (32).

9. The telescopic gate barrier according to claim 8, wherein the mounting plate (11) is provided with an axial hole (111) and an accommodation hole (112) that are interconnected, and the axial hole (111) and the accommodation hole (112) are along the axial direction of the torsion spring (5); and
the end mounting member (32) comprises a sleeve (321) and an end plate (322) that are fixed to each other, a diameter of the end plate (322) is larger than a diameter of the sleeve (321), the sleeve (321) is sleeved over the rotating drum (3), the end plate (322) is located in the accommodation hole (112), and the rotation locking member (8) is configured to lock rotation of the end plate (322).

10. The telescopic gate barrier according to claim 9, wherein the rotation locking member (8) comprises a compression ring (81), and the compression ring (81) extends into the accommodation hole (112) and is threadedly connected to the mounting plate (11) to compress the end plate (322).
